(19) United States
(12) Patent Application Publication
(10) Pub. No.: US 2026/0131541 A1
(43) Pub. Date: May 14, 2026

(54) DEVICES, SYSTEMS, AND METHODS FOR MOBILE PIPE FORMATION PLANT

(71) Applicant: Babak Torabi, Port Coquitlam (CA)

(72) Inventor: Babak Torabi, Port Coquitlam (CA)

(21) Appl. No.: 19/387,285

(22) Filed: Nov. 12, 2025

Related U.S. Application Data
(60) Provisional application No. 63/720,166, filed on Nov. 13, 2024.
(60) Provisional application No. 63/720,170, filed on Nov. 13, 2024.

(51) Int. Cl. B29C 70/32; B29C 70/54; B29L 23/00

(52) U.S. Cl. CPC B29C 70/32; B29C 70/545; B29C 70/546; B29L 2023/22

(57) ABSTRACT

Systems, devices, articles and methods for a mobile pipe winder including a frame, a mandrel, a plurality of material feeds coupled to the frame, and a lift coupled to the frame and underlying the mandrel. The mobile pipe winder further comprises a trimmer-finisher coupled to the frame and including a saw and a chamferer. The mobile pipe winder also comprises a plurality of disks coupled to and spaced along the mandrel. The plurality of material feeds includes a mobile sand silo, detachable roving feeds, and resin tanks.

### CROSS-REFERENCE TO RELATED APPLICATIONS

This application claims priority to and incorporates by reference U.S. provisional applications: Ser. No. 67/957,884, filed 2024 Nov. 13 and Ser. No. 63/720,166 filed 2024 Nov. 13.

### TECHNICAL FIELD

The disclosure relates to devices, systems, and methods related to the manufacturing of pipes. More specifically, the disclosure relates to apparatuses and systems (e.g., a mobile pipe winder) to produce pipes (e.g., Fiberglass Reinforced Plastic (FRP)) and associated methods.

### BACKGROUND

The purpose of the following description of related art is solely to provide background information pertaining to the relevant field of the disclosure. It should be noted that this section is only to enhance the understanding of the reader with respect to the present disclosure. Therefore, unless otherwise indicated, it should not be assumed that any of the information described in this section qualifies as prior art merely by their inclusion in this section.

Fiberglass pipes, or Fiberglass Reinforced Plastic (FRP) pipes, are composite materials made from a polymer matrix reinforced with glass fibers and other materials. These pipes are known for their strength, low mass, durability, and corrosion resistance, making them suitable for a wide range of applications. Lower mass and lower rotational inertia than traditional metal pipes make the FRP pipes easier to handle and install. Despite their lightweight nature, FRP pipes offer high tensile strength and can withstand significant pressure. FRP pipes are highly resistant to corrosion from water (e.g., fresh, sea, grey, waste), chemicals, seawater, and wastewater making them suitable for use in various applications, including water and wastewater systems, chemical processing, and oil and gas industries.

Another common name for FRP pipes is Glass Reinforced Plastic (GRP). Both terms refer to the same type of composite material, which is made from a polymer matrix reinforced with glass fibers. Examples of the polymer matrix include those made from epoxy, polyester, phenolic, and vinyl resins. FRP pipes may include within the matrix other materials such as fillers, wherein the known fillers include fine aggregates such as silica sand and enhance the stiffness of the pipes.

### SUMMARY

This section is intended to introduce certain objectives and aspects of the present disclosure in a simplified manner. The disclosure relates to a system to make pipes.

A mobile pipe winder includes a frame a frame including an inferior side and a major axis. The winder further includes a plurality of mounts defined on the inferior side of the frame, and a mandrel including a first end coupled to the frame, and a second end projected along the major axis of the frame. Further, the winder includes a plurality of material feeds which in operation are coupled to the frame, and a lift coupled to the frame and underlying the mandrel.

A method of operation in a mobile pipe formation apparatus, pipes made by the mobile pipe formation apparatus are Fiberglass Reinforced Plastic pipes. The method includes preparing the mobile pipe formation apparatus. The mobile pipe formation apparatus includes a mandrel, and a plurality of material feeds. The method includes applying materials from the plurality of material feeds, and turning the mandrel. The materials overly the mandrel. The method includes trimming a pipe including the materials at a first end, and after trimming, removing the pipe from the mandrel.

This summary does not necessarily describe the entire scope of all aspects. Other aspects, features, and advantages will be apparent to those of ordinary skill in the art upon review of the following description of specific embodiments.

### BRIEF DESCRIPTION OF DRAWINGS

Systems, devices, and methods are described in greater detail herein with reference to the following figures in which:

FIG. 1 is a perspective view of a mobile pipe formation apparatus and hydrostatic pressure test apparatus in transportation configurations.

FIG. 2 is a perspective view of the mobile pipe formation apparatus and hydrostatic pressure test apparatus in deployed configurations.

FIG. 3 is a perspective view of the testing apparatus in deployed configuration.

FIG. 4 is a perspective view of a tailstock frame included in the hydrostatic pressure test apparatus.

FIG. 5 is a section view of the hydrostatic pressure test apparatus along section line 5-5′ shown in FIG. 3.

FIG. 6 is an elevation view of the hydrostatic pressure test apparatus from the nearside shown in FIG. 3.

FIG. 7 is a perspective view of a detail of the hydrostatic pressure test apparatus shown in the previous figures.

FIG. 8 is a perspective view of a detail of the hydrostatic pressure test apparatus.

FIG. 9 is a section view of the hydrostatic pressure test apparatus and a pipe under test from section line 9-9′ shown in FIG. 6.

FIG. 10 is a perspective view of a lift included in the hydrostatic pressure test apparatus.

FIG. 11 illustrates a flow diagram of a method of operation of a hydrostatic pressure test apparatus.

FIG. 12 is a perspective view of the mobile pipe formation apparatus in transportation configuration.

FIG. 13 is an elevation view of the mobile pipe formation apparatus in an intermediate configuration between transportation and deployed configurations.

FIG. 14 is a perspective view of a mandrel having a plurality of ferrules attached and distributed along its length.

FIG. 15 is a section view along the major axis of the mandrel shown in FIG. 14.

FIG. 16 is a plan view of a ring which may be fitted into the mandrel shown in FIG. 14.

FIG. 17 is an end view of a mobile manufacturing device shown in FIG. 12.

FIG. 18 is an elevation view (from the side) of a mobile manufacturing device shown in FIG. 12.

FIG. 19 illustrates various views of a feeder system having a fixed structure and a vertical moveable platform.

FIG. 20 is a perspective view of the mobile pipe formation apparatus having a sand shooter installed above it and attached to the mandrel.

FIG. 21 is a perspective view of the hydrostatic pressure test apparatus and a sand silo in transportation configuration.

FIG. 22 illustrates multiple views of the sand silo.

FIGS. 23a and 23b illustrate a detachable roving feed and a resin tank.

FIG. 24 illustrates a flow diagram of a method of operation of a pipe winder.

The above-mentioned drawings illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. Also, the embodiments shown in the figures are not to be construed as limiting the invention but only as illustrative examples of an automated method and system according to the inventions illustrated herein to highlight the advantages of the invention.

### DETAILED DESCRIPTION

In the following description, associated drawings, included claims, and other parts of the document, various details are set forth to provide a detailed understanding of the disclosure and embodiments thereof. It will be apparent, however, that the disclosed embodiments may be practiced without these details. Several features described hereafter can each be used independently of one another or with any combination of other features.

While our collective attention may be drawn to other innovations, the applicant appreciates the critical importance of clean water and sanitation to reduce exposure to countless diseases and conditions. Every year, millions of people die from diseases caused by inadequate water supply and sanitation. Indeed, diarrhea is the second leading cause of death in young children. Further, access to clean water is still unevenly distributed and is one of the biggest concerns. Likewise, the improper handling of wastewater (e.g., effluent, sewage) leads to negative outcomes on our environment and health. This happens for many reasons including lack of the correct components, such as pipes. Therefore, industrial processes involving fluid must minimize their impact with proper fluid-handling components.

Transporting FRP pipes is possible but expensive since pipes don't pack well in standard shipping forms. Setting up traditional FRP pipe factories in locations that need improved infrastructure is impractical due to many reasons such as unwieldy apparatus and bad roads especially in underdeveloped regions that face challenges related to water availability, robust roads, and other remote infrastructure.

In view of the above-mentioned problems and challenges, the Applicant appreciates there is a need for mobile systems, devices, and methods to produce FRP pipes.

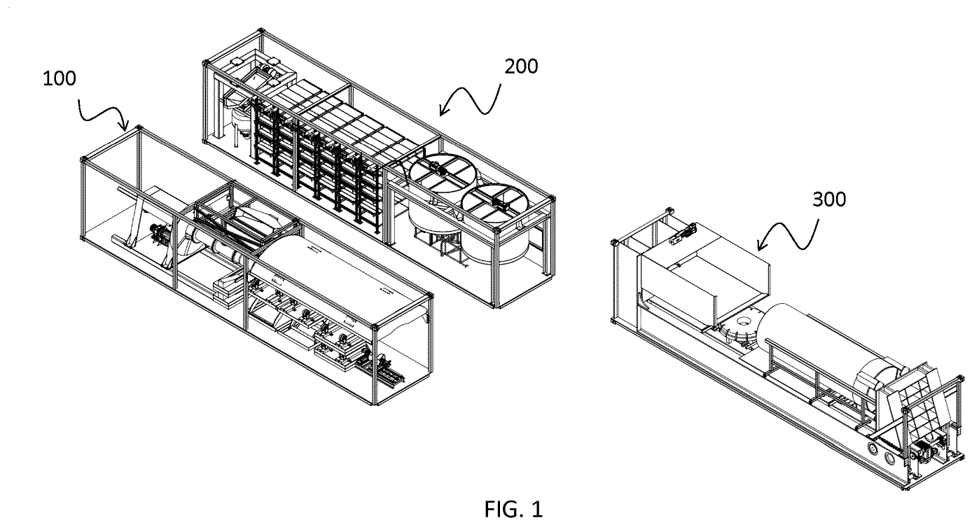

FIG. 1 illustrates a perspective view of pipe formation apparatus 100 in transportation configuration. The pipe formation apparatus 100 may produce resin fiber pipes. In some embodiments, pipe formation apparatus 100 fits, in a transportation configuration, in a standard ISO 668 intermodal container form. For example, a 1AAA 40 or 40 ft High Cube form factor includes a frame with external dimensions, 8 feet wide, 9.5 feet high, and 40 feet long (2.44 m by 2.90 m by 12.20 m). In some embodiments, the container form is a 1AA form factor or a 40 ft Container including a frame with external dimensions, 8 feet wide, 8.5 feet high, and 40 feet long (2.44 m by 2.60 m by 12.20 m). Also shown in FIG. 1 is a material stores container 200 holding one or more supplies or materials used in the construction of pipes. In some embodiments, material stores container 200 holds material such as filament or roving spools, mat, resin, and filler. The material stores container may be an intermodal container of a size the same or different used for pipe formation apparatus 100.

Also shown in FIG. 1 is a hydrostatic pressure test apparatus 300. In some embodiments, material stores container 200 or hydrostatic pressure test apparatus 300 has a transportation configuration that conforms to a standard ISO 668 intermodal container form which may be different in size to material stores container 200 or a container holding pipe formation apparatus 100.

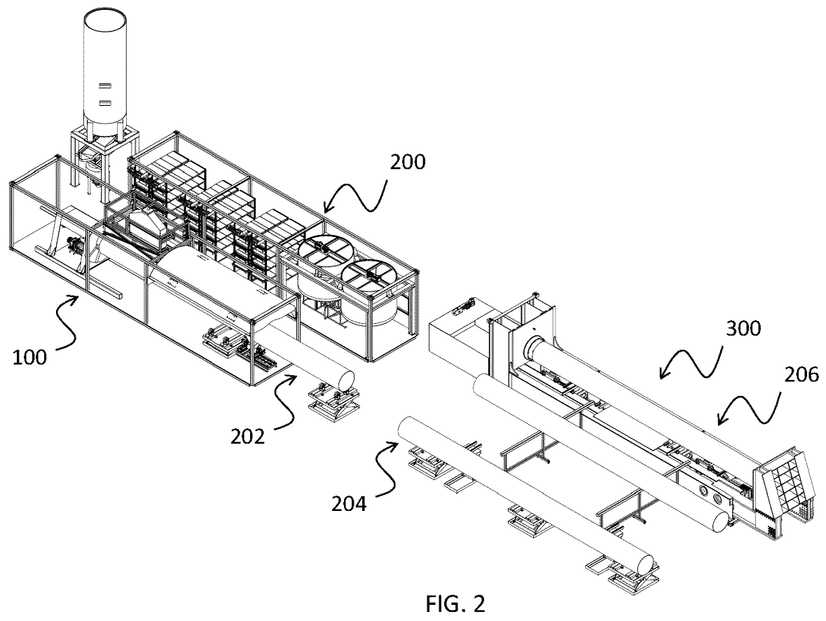

Turning to FIG. 2 which illustrates a perspective view of pipe formation apparatus 100, material stores container 200, and hydrostatic pressure test apparatus 300 each in a deployed configuration. The pipe formation apparatus 100 is configured to produce resin fiber pipes such as pipe 202, including fiber (e.g., filament, mat, or roving) wound around a mandrel and impregnated with resin and filler (e.g., sand). In operation, pipes manufactured at pipe formation apparatus 100 (e.g., pipe 204) may be transferred by a material handling system to hydrostatic pressure test apparatus 300—e.g., pipe under test 206. For example, the material handling system may include guides, jacks, lifts, rollers, saddles, stands, tables, turntables, and the like.

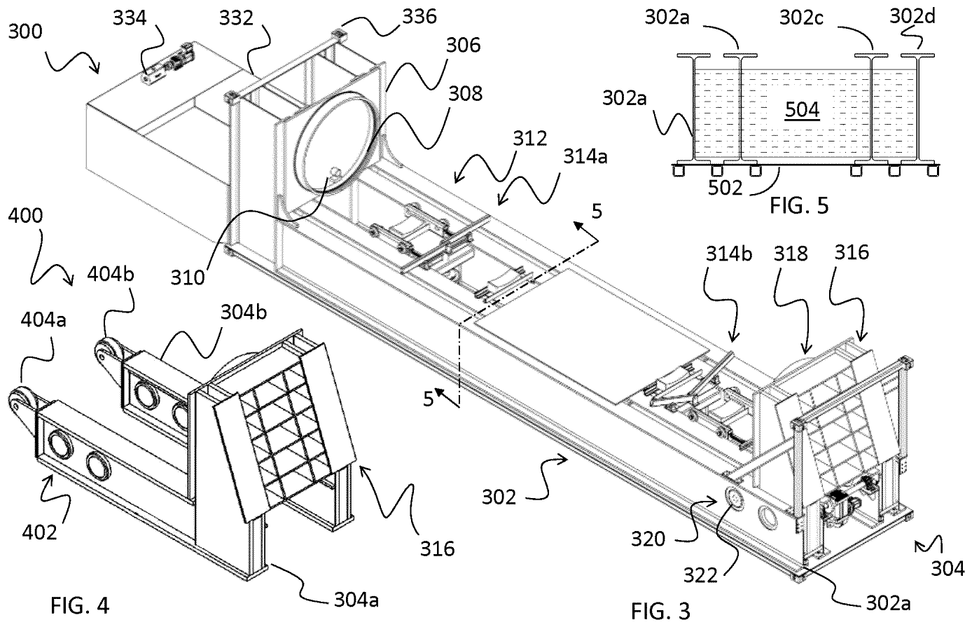

Turning to FIG. 3, which illustrates a perspective view of hydrostatic pressure test apparatus 300 including a first plurality of beams 302 disposed below the pipe under test, and a second plurality of beams spaced apart from the first plurality of beams 302 such that the first plurality of beams 302 and second plurality of beams 304 may move longitudinally relative to each other without interference.

Hydrostatic pressure test apparatus 300 includes a first upright member, conventionally called a headstock 306 is rigidly coupled to the first plurality of beams 302. In some embodiments, hydrostatic pressure test apparatus 300 includes a first seal 308 on the proximal side of headstock 306. The first seal 308 encloses an interior of space within which is an inlet 310.

Fluid may enter a pipe under test by inlet 310. In some embodiments, inlet 310 is located near the bottom of first seal 308, whereas in known test machines, the inlet is centered, requiring the pipe to be lifted to a higher position.

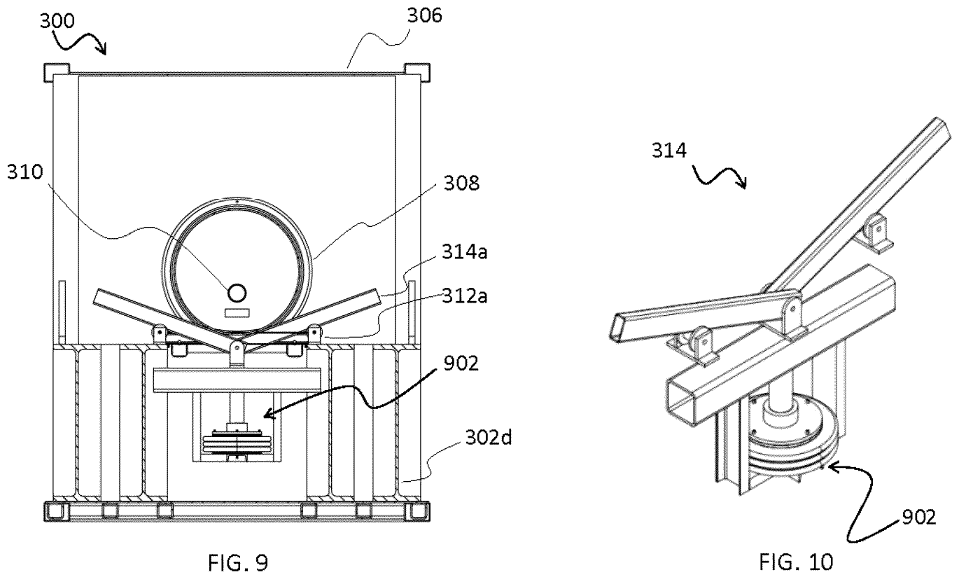

Pipes under test (e.g., pipe under test 206) may be supported by one or more bodies, such as saddle 312 overlying first plurality of beams 302. The saddle 312 may be one of one or more supports for pipe under test 206. In some embodiments, saddle 312 transfers several tons to first plurality of beams 302. In some embodiments, a pipe under test may be moved or supported by one or more lifts such as pneumatic lifts. For example, as shown, hydrostatic pressure test apparatus 300 includes a first lift 314a and a second lift 314b. These are further described herein in relation to, at least, FIG. 9 and FIG. 10.

Hydrostatic pressure test apparatus 300 includes a second upright member, conventionally called for clarity, a tailstock 316 rigidly coupled to the second plurality of beams 304 and a second seal 318 on the proximal side of tailstock 316 facing headstock 306. A person of skill in the art will appreciate that the terms head and tail provide clarity and could be reversed in other embodiments. In operation, hydrostatic pressure test apparatus 300 can hold a pipe under test between headstock 306 and tailstock 316. A pipe under test can be lifted into place to have a sealed engagement with first seal 308 or second seal 318.

In some embodiments, hydrostatic pressure test apparatus 300 includes a first plurality of holes 320 defined in first plurality of beams 302. At least one pin 322 engages the first plurality of holes 320 and couples first plurality of beams 302 to second plurality of beams 304 preventing relative motion of first plurality of beams 302 and second plurality of beams 304 along their respective shared principal axis.

In some embodiments, an actuator (not shown in FIG. 3) urges or moves at least one pin 322 fit into or out of a fit with at least one hole in the first plurality of holes 320. The at least one pin couples first plurality of beams 302 and second plurality of beams 304. For example, holds first plurality of beams 302 and second plurality of beams 304 in relative place when a pipe is tested. In some embodiments, the hydrostatic pressure test apparatus 300 includes four pins. For example, two on each side. In some embodiments, the at least one pin is moved by a jack, e.g., a hydraulic jack, a pneumatic jack, or a screw jack. In some embodiments, hydrostatic pressure test apparatus 300 includes a motor, pinion, and rack described further in FIG. 7.

Turning to FIG. 4 which illustrates a perspective view of tailstock frame 400 including second plurality of beams 304, and tailstock 316. The second plurality of beams 304 includes a second plurality of holes 402 to receive at least one pin 322. An actuator (as described in, at least, FIG. 3) urges or moves at least one pin 322 to move into or out of fit with second plurality of holes 402.

Second plurality of beams 304 includes beam 304a and beam 304b. In some embodiments, one or more of beam 304a or beam 304b includes a roller or caster at their distal end. For example, caster 404a and caster 404b.

FIG. 5 is a section view of the hydrostatic pressure test apparatus along section line 5-5′ shown in FIG. 3. As shown, first plurality of beams 302 are spaced apart in the lateral direction. Inferior to the first plurality of beams 302 (e.g., beam 302a, beam 302b, beam 302c, and beam 302d) is web 502 in sealed coupling with at least two beams in plurality of beams 302 (e.g., beam 302a, and beam 302d). Web 502, one or more beams in plurality of beams 302, and other bodies define a prism. And in some embodiments, web 502, one or more beams in plurality of beams 302 include one or more parts of a first reservoir, e.g., basin, container, pool, tank, or vessel, for fluid 504. The seams between web 502, one or more beams in plurality of beams 302, and other bodies, e.g., end web (not shown). For example, hold fluid 504 in a deployed configuration such as those shown in FIG. 2 and FIG. 3.

A person of ordinary skill in the art will appreciate the content of FIG. 5, the space or prism defined by web 502, one or more beams in plurality of beams 302 include one or more parts of a first reservoir reducing or eliminating the need for an external pool, such as, a large concrete water pool. Thus, hydrostatic pressure test apparatus 300 is mobile (e.g., portable), flexible, or useable.

Returning to FIG. 3. In some embodiments, hydrostatic pressure test apparatus 300 further includes a second reservoir 332, disposed outside of first plurality of beams 302 and in fluid communication with the first reservoir. In some embodiments, hydrostatic pressure test apparatus 300 includes a pump 334 to transfer fluid from the first reservoir (not shown in FIG. 3) or second reservoir 332 into a pipe under test.

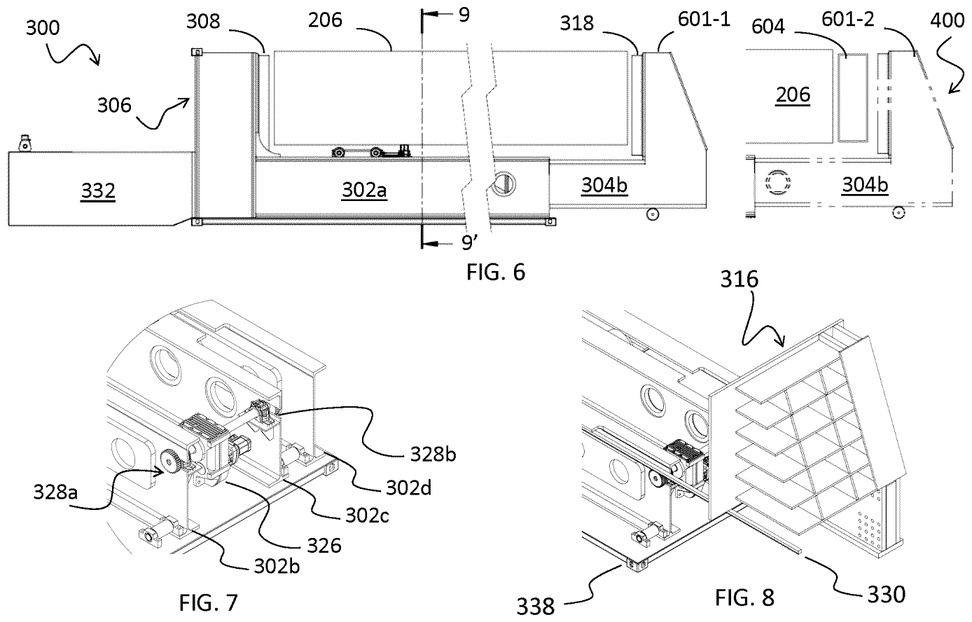

Turning to FIG. 6, which illustrates an elevation view of hydrostatic pressure test apparatus 300 and a pipe under test 206. In operation, hydrostatic pressure test apparatus 300 holds pipe under test 206 above first plurality of beams 302 or above first plurality of beams 302 and between headstock 306 and tailstock 316. Once pipe under test 206 is moved into place (e.g., lifted) first seal 308 or second seal 318 provide a fluid seal on pipe under test 206.

As shown in FIG. 6 tailstock frame 400 operates in a plurality of positions including a first position 601-1 and a second position 601-2. The movement from second position 601-2 to first position 601-1 to second position 601-2 provides a clamp on pipe under test 206. Readers will appreciate that despite being transported within a form factor of confined length, embodiments of hydrostatic pressure test apparatus 300 can test pipes of comparable length. For example, with a 12 m container, the hydrostatic pressure test apparatus 300 has a telescopic beam system including first plurality of beams 302 and second plurality of beams 304 that accommodate pipes up to about 12 meters in length.

In some embodiments, the pipe under test 206 includes a bell end (not shown). A coupler 604 may be placed between flared or bell end and the headstock 306 or tailstock 316. In some implementations, coupler 604 is made from a cut section of pipe.

Turning to FIG. 7 which illustrates in perspective view a first end of hydrostatic pressure test apparatus 300, and in particular, the near end as shown in FIG. 3. As shown, hydrostatic pressure test apparatus 300 includes first plurality of beams 302, such as beam 302b, beam 302c, and beam 302d. In some embodiments, hydrostatic pressure test apparatus 300 includes a motor 326 coupled to the first plurality of beams 302 and driving one or more pinions, e.g., pinion 328a, and pinion 328b.

Turning to FIG. 8 which illustrates in perspective and cutaway view, the first end of hydrostatic pressure test apparatus 300 and tailstock frame 400. The one or more pinions 328 engage one or more racks 330 coupled to tailstock frame 400. The motor 326 drives one or more pinions 328, one or more racks 330, and tailstock frame 400. Thus, in response to instructions, such as processor executable instructions motor 326 position tailstock frame 400 and headstock 306 in relative position for a pipe under test. In some embodiments, a plurality of pins (e.g. pins 322) provides a clamping force for a pipe under test. In some embodiments, motor 326 drives one or more pinions 328 engaged with one or more racks 330 to move tailstock 316. The action of the motor can be controlled by contact switches. For example, once the holes in first plurality of beams 302 are aligned with holes in second plurality of beams 304.

In some embodiments, when the pipe under test is squared between the two sealing points, the motor stops by a microswitch. Pins 322 are aligned with the holes and inserted an actuator such as a hydraulic jack. The engage pins lock in place tailstock frame 400, headstock 306, and the pipe under test. The pipe is then filled with water until the target pressure is reached (e.g., 32 bars, generating an internal force of 380 tons on both the headstock and tailstock). The pins 322 are designed to securely hold this pressure, as only they can withstand this level of force.

Turning to FIG. 8 hydrostatic pressure test apparatus 300 includes one or more mounts such as superior mount 336 and inferior mount 338. In some embodiments, at least one mount, e.g., inferior mount 338 is a corner casting as defined in ISO 1161 and may receive a twist lock. In some embodiments, headstock 306 is incorporated into the body separating an inferior and superior mount. The one or more mounts may be used in a transport configuration like shown in FIG. 1 or a deployed configuration shown in FIG. 2.

FIG. 9 is a section view of the hydrostatic pressure test apparatus from section line 9-9′ shown in FIG. 6. Hydrostatic pressure test apparatus 300 includes a headstock 306 rigidly coupled to the first plurality of beams 302. In some embodiments, hydrostatic pressure test apparatus 300 includes a first seal 308 on the proximal side of headstock 306. The first seal 308 encloses an interior of space within which is an inlet 310. Fluid may enter a pipe under test by inlet 310. In some embodiments, hydrostatic pressure test apparatus 300 includes a plurality of stops coupled to headstock 306, which in operation receive a pipe under test. In some embodiments, the plurality of stops has a wedge or frustoconical profile.

In some embodiments, hydrostatic pressure test apparatus 300 includes a first saddle 312a overlying first plurality of beams 302 and supporting a pipe under test (e.g., pipe under test 206). In some embodiments, a pipe under test may be supported by one or more lifts, such as, first lift 314a. In some poses the pipe under test is supported by one or more saddles such as saddle 312.

In some embodiments, first lift 314a is driven by a pneumatic actuator 902. Applicant appreciates that their choice of pneumatic lift 914, including a pneumatic actuator 902, helps make the hydrostatic pressure test apparatus 300 (and indeed the entire manufacturing system) more mobile and sustainable versus a hydraulic system where leaks (e.g., of hydraulic fluid like mineral or synthetic oil) would contaminate the fluid (e.g., water) in the pipe under test. See, for example, fluid 504 in FIG. 5.

As can be appreciated in FIG. 9 and FIG. 10, in operation pneumatic lift 914 in response to air pressure provided or mediated by pneumatic actuator 902 moves the pipe under test. The pneumatic lift 914 lifts (e.g., raises, lowers, or supports) the pipe under test—e.g., before, during, testing. During testing the pipe under test and fluid within are supported by one or more bodies such as saddle 312. When filled, a ten meter length of 1000 mm pipe weighs almost eight tons and a pipe of 12 meters and 1500 mm is almost twenty-one tons of water. The plurality of beams 302 may be of a length to handle 12 meter pipes.

In some embodiments, pneumatic actuator 902 rigidly coupled to first plurality of beams 302 and supports pneumatic lift 914. The pneumatic lift 914 may include pivotable couplings to one or more arms and thus accommodate different sizes of pipes. The arms may form a T with vertical parts of pneumatic lift 914 which is useful to roll pipe under test 206. As shown in FIG. 9 or FIG. 10, the arms may form a Y with vertical of pneumatic lift 914 which is useful to prevent roll of pipe under test 206 or park pipe under test 206 in a saddle such as saddle 912. Pneumatic lift 914 may bring the pipe under test into position to be held by saddle 312. In some embodiments, in this position the pipe under test mates with seal first 308 and second seal 318. In a retracted state pneumatic lift 914 allows for the pipe under test (e.g., pipe under test 206) to be moved in or out of hydrostatic pressure test apparatus 300. The Applicant appreciates there are unique ways to hydrostatic pressure test apparatus 300.

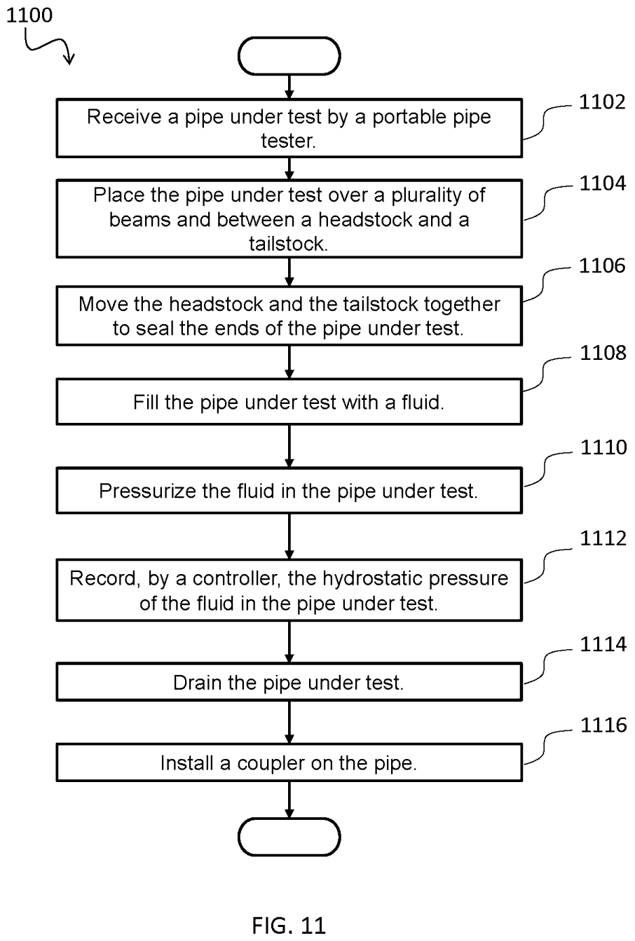

FIG. 11 illustrates a flow diagram of a method of operation of a hydrostatic pressure test apparatus also called a pipe tester. In particular, FIG. 11 shows method 1100 executable by one or more operators of a mobile pipe tester (e.g., hydrostatic pressure test apparatus 300). The mobile pipe tester may be communicatively coupled, such as by circuitry, to a controller such as at least one hardware processor, for the operation, or improvement in the operation, of the hydrostatic pressure test apparatus. One or more parts of method 1100 may be performed by the controller. For method 1100 as with other methods disclosed herein, a person skilled in the art will appreciate that other acts may be included, removed, and/or varied or performed in a different order to accommodate alternative implementations.

At 1102, the operators receive a pipe under test by a mobile pipe tester. In some embodiments, the operators receive the pipe under test (e.g., pipe under test 206) on a saddle (e.g., saddle 312) supported by the plurality of beams (e.g., first plurality of beams 302).

At 1104, the operators, place the pipe under test over a plurality of beams and between a headstock and a tailstock. In some embodiments, the mobile pipe tester further includes a pneumatic lift coupled to the plurality of beams, and placing the pipe under test over a plurality of beams further consists of, in response to adjusting the pressure in the pneumatic lift, changing the height of the pipe under test. In some embodiments, the pipe under test simply sits on saddle 312 and is centered and squared for testing. In some embodiments, adjusting pressure in the pneumatic lift (e.g., lift 314) is done in response to executing processor-executable instructions. In some embodiments, the mobile pipe tester further includes a plurality of saddles overlying a frame and underlying the pipe under test. The pneumatic lift, in response to adjusting pressure in the pneumatic lift, brings the pipe under test to rest on one or more saddles in the plurality of saddles, or lifts the pipe under test from one or more saddles in the plurality of saddles.

At 1104, in some implementations, the mobile pipe tester includes a lift including two positions: UP and DOWN. The UP position is designated for moving a pipe under test and the DOWN position brings the pipe under test to rest in one or more saddles. The up position may correspond to the T shape and the down position to the Y shape described above for lift 914. The use of an UP and DOWN position eliminates the need for manual adjustment of pipe elevation, reducing the risk of pipe damage and saving time.

At 1106, the operators move the headstock and the tailstock together (e.g., towards each other) and, in response, the headstock and the tailstock seal the ends of the pipe under test. For example, the operators direct the controller to execute processor executable instructions, which, when executed, cause the tailstock (e.g., tailstock 316) to move toward the headstock. For example, the operators use motor 326 to drive pinion(s) 328 engaged with rack(s) 330 coupled to tailstock frame 400. In response to motivating motor 326, the tailstock frame 400, and tailstock 316 are driven toward headstock 306 and clamp the pipe under test. In some implementations, headstock 306 is fixed to first plurality of tension beams 302 and a rack and pinion moves tailstock 316 to moved towards headstock 306. In some implementations, the operators or the controller activates a motor to drive a rack and pinion that pushes the tailstock against the pipe under test and clamps the pipe under test between the headstock and the tailstock.

In some implementations, at 1106 a motor coupled to the rack and pinion moves tailstock 316, pushing a pipe under test into a sealed position. When the pipe under test is squared between the two sealing points, the motor stops by a microswitch once the at least one pin are aligned with the holes in the first plurality of beams 302 and the second plurality of beams 304. In some embodiments, the at least one pin are moved by a jack, e.g., hydraulic jack, pneumatic jack, or screw jack. For example, the jack pushes a pin in pins 322 into a first hole in beam 302a and hole 402 in beam 304a. Once repeated for a plurality of pins beams 302 and beam 304 are held in relative position. The pipe is then filled with a fluid such as water. For example, at 32 bars there is an internal force of 380 tons on both headstock 306 and tailstock 316. The at least one pin 322 holds against the internal tension force provided by the fluid.

In some implementations, at 1106 a coupler is placed on the pipe under test on a first end between the headstock 306 or tailstock 316. For example, at 1106, tailstock 316 is moved to a predetermined distance from the end of the pipe under test. A coupler, such as coupler 604, is added and tailstock 316 is moved again to seal the pipe under test. In some implementations, after method 1100, coupler 604 is placed on the pipe at 1106 removing the need for a separate machine to install coupler 604. In some implementations, after method 1100, coupler 604 is placed on the pipe.

At 1108, the operators fill the pipe under test with a fluid. For example, fluid 504, such as water. In some embodiments, the mobile pipe tester further includes a reservoir and a filter in fluid communication with the reservoir. At 1108 the operators may filter the fluid. In some embodiments, the operators transfer the fluid between the reservoir and the pipe under test. For example, fill the pipe under test from the reservoir.

At 1110, the operators pressurize the fluid in the pipe under test (e.g., pipe under test 206). The operators may run pump 334. In some implementations, a first pump provides fluid at a high volume, but low pressure, and a second pump provides fluid at higher pressure, e.g., up to 64 MPa. The pressure in the fluid under test varies with embodiments and specifications of the pipe. In some implementations, the pressure is two (2) times atmospheric pressure. In some implementations, the pressure is a multiple of the intended max working normal pressure of the pipe. For example, twice the normal pressure of the pipe. For a 1000 mm pipe with a 16 bar normal pressure, the test pressure is 32 bar or 32 MPa.

At 1112, the controller records the hydrostatic pressure of the fluid in the pipe under test. Data logging of site-built pipes provides quality assurance. In some embodiments, the controller displays a plurality of values of the hydrostatic pressure in the pipe under test over time. For example, five minutes.

At 1114, the operators drain the pipe under test. For example, the fluid in the pipe under test is transferred to a reservoir.

At 1116, in some implementations after 1114, a coupler 604 is placed or installed on the pipe. In some implementations, coupler 604 is placed on a first end of the pipe. Method 1100 ends until invoked again.

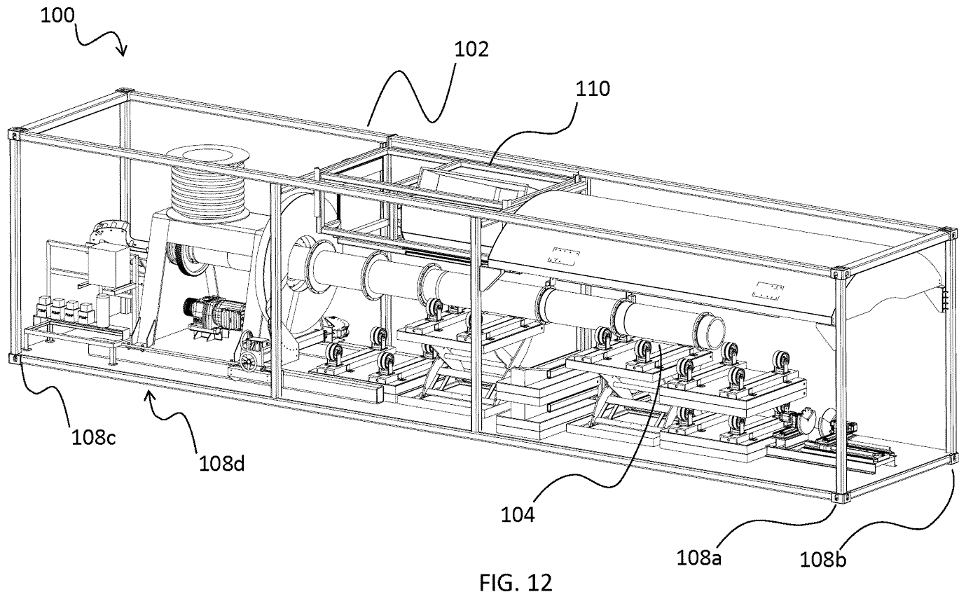

Turning to FIG. 12 which illustrates, in perspective view, a mobile pipe formation apparatus 100 in transportation configuration. FIG. 12 is a variation of the view shown in FIG. 1. The pipe formation apparatus 100 is also known as a continuous filament winding machine, mobile pipe winder, mobile winding machine, or pipe formation apparatus 100. Pipe formation apparatus 100 includes a frame 102, and a mandrel 104 coupled to frame 102. Also, pipe formation apparatus 100 includes a plurality of material feeds which in operation are coupled to frame 102. Examples of the plurality of material feeds include a mobile sand silo (not shown in this figure).

Frame 102 includes a plurality of mounts 108 such as mounts 108a, 108b, 108c, and 108d defined on the inferior of frame 102. In some embodiments, mounts 108 are ISO 1161 corner castings. Frame 102 includes an inferior side, a superior side, a minor axis, and a major axis, such that the major axis is longer. In some embodiments, some mounts in plurality of mounts 108 are spaced apart along the major axis of frame 102. While in some embodiments, one or more mounts in plurality of mounts 108 are spaced apart on the minor axis. In some embodiments, one or more mounts in plurality of mounts 108 are located on the inferior side of frame 102. In some embodiments, mounts 108a, 108b, 108c, and 108d are located at corners of the inferior side of frame 102. As shown in FIG. 12, mount 108a is situated on a different side of frame 102 to mount 108b. Similarly, mount 108c is on a different side than mount 108d.

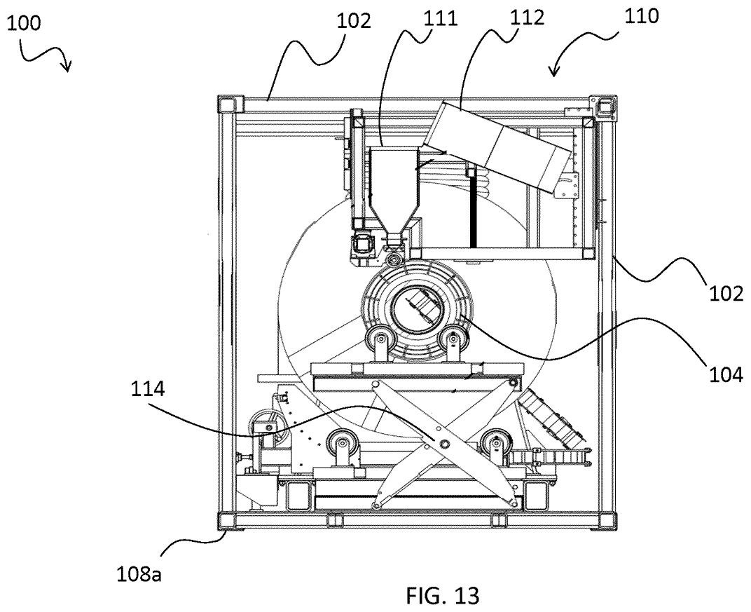

Turning to FIG. 13, the mobile pipe formation apparatus 100 is in an intermediate configuration between transportation and deployed configurations. In some embodiments, the pipe formation apparatus 100 includes a lift 114 and a sand applicator 110. In some embodiments, lift 114 includes a first configuration and a second configuration. In the first configuration, lift 114 is locked off and supports mandrel 104 by distributing part of the mass of mandrel 104 to frame 102. In the second configuration, lift 114 supports a pipe, as a workpiece. In some embodiments, lift 114 includes a multi-bar linkage. Therefore, lift 114 is coupled to frame 102 and underlying the mandrel 104. As shown, lift 114, in the first configuration, is locked in place with one or more bodies, e.g., pins constraining motion of at least one link or at least one bar in the multi-bar linkage.

In some embodiments, sand applicator 110 is foldable. In a first configuration sand shooter 110 is folded and in a second configuration applicator 110 is unfolded. The applicator 110 includes a fixed part 111 and a moveable part 112. Moveable part 112 is swung down during transport mode and quickly converted to operational mode when needed. In the second configuration, lift 114 supports a pipe, as a workpiece, and sand applicator 110 is in a closed state with moveable part 112 atop fixed part 111. Therefore, the moveable part 112 is adjustable. In some embodiments, the sand applicator 110 is in coordination with the movement of lift 114. In the first configuration, lift 114 is locked off and supports mandrel 104 by distributing the mass of mandrel 104 to frame 102. In the second configuration, lift 114 supports a pipe, as a workpiece, and the sand applicator 110 is in a closed state.

Further, frame 102 has a form factor of a shipping container. In some embodiments, the shipping container is as per ISO 668 intermodal container form. In some embodiments, the container form is a 1AAA form factor or a 40 ft high cube container including a frame with external dimensions, 8 feet wide, 9.5 feet high, and 40 feet long (2.44 m by 2.90 m by 12.20 m).

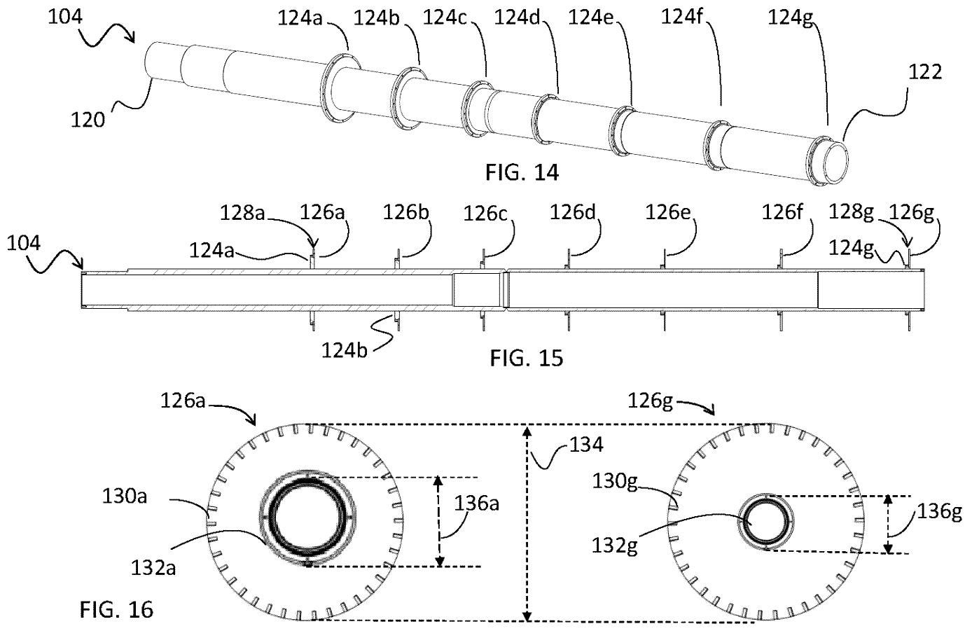

Turning to FIG. 14, FIG. 15, and FIG. 16 which illustrate aspects of mandrel 104 including a first end (e.g., proximal end 120) and a second end (e.g., distal end 122). In some embodiments, the mandrel 104 is rotatably coupled to frame 102 near the proximal end 120. In some embodiments, mandrel 104 is cantilevered from proximal end 120. In some embodiments, distal end 122 of the mandrel 104 projects along the major axis of frame 102.

In some embodiments, a plurality of disks 128 are coupled to, projected from, and are spaced along the mandrel 104. The plurality of disks 128 includes a plurality of ferrules 124 and a plurality of rings 126. As shown, plurality of ferrules 124 includes ferrules 124a-124g. For example, a respective disk in plurality of disks 128 includes a respective ferrule (e.g., ferrule 124a) and a respective ring (e.g., ring 126a). The plurality of ferrules 124 are coupled to and distributed along the major axis of mandrel 104—e.g., along the length. In some embodiments, plurality of ferrules 124 and plurality of rings 126 are evenly distributed along the axis of the mandrel 104. In some embodiments, plurality of ferrules 124 may be fitted into the mandrel 104 as shown in FIG. 14.

In some embodiments, plurality of ferrules 124 includes monotonically (e.g., always decreasing, or the same or decreasing) radii. The diameter of each respective ferrule in plurality of ferrules 124 is the same value or a smaller value than the diameter of a more proximally located ferrule. In some embodiments, plurality of ferrules 124 includes a partial ordering of diameters such that the largest diameter is proximate to proximal end 120 and the smallest diameter is near distal end 122.

In some embodiments, plurality of rings 126 is detachably coupled to plurality of ferrules 124. For example, a respective ring (e.g., ring 126b) is detachably coupled to a respective ferrule (e.g., ferrule 124b).

As shown in FIG. 16, a respective ring in plurality of rings 126 includes an inner periphery characterized by an inner diameter and an outer periphery characterized by an outer diameter. A disk 128 is defined by an outer periphery 130. In some embodiments, a pair of disks share an outer diameter. For example, both rings 126a and 126b are characterized by a common outer diameter shown by length 134. For example, ring 126a includes an inner periphery 132a having an inner diameter as shown by length 136a. Compare ring 126a to ring 126g, which includes an inner periphery 132g having a smaller inner diameter, as shown by length 136g.

Considering FIG. 14, FIG. 15, and FIG. 16, a respective ring in plurality of rings 126 includes an inner diameter and an outer diameter. In some embodiments, plurality of rings 126 has a monotonically increasing inner diameter from smallest at distal end 122 to largest at proximal end 120. More particularly, ring 126a has a bigger inner diameter than ring 126g. In operations with plurality of ferrules 124 including varying outer diameters, when installing or removing a ring in the plurality of rings 126 the changing in diameters provides free clearance over distally placed ferrules in the plurality of ferrules 124.

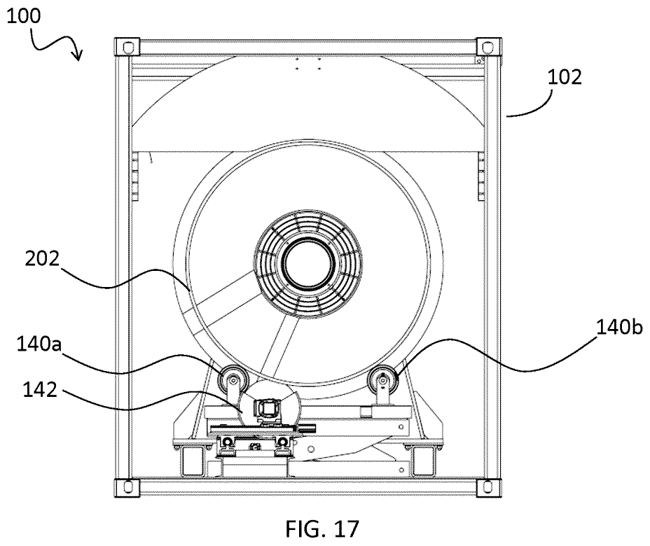

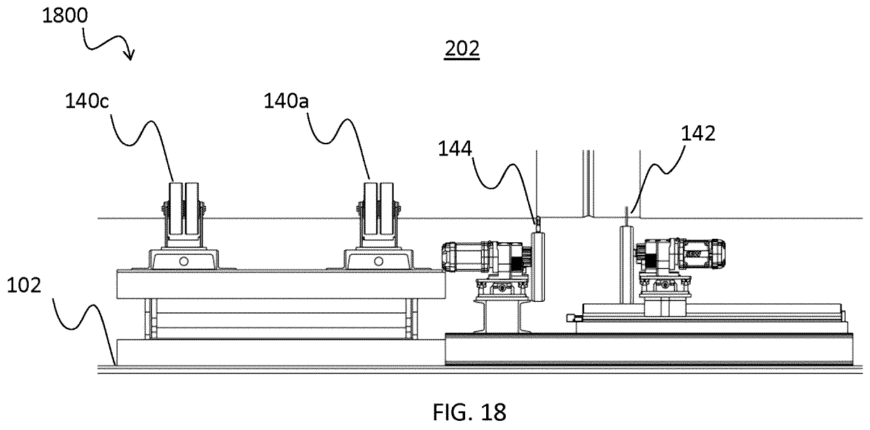

FIG. 17 is an end elevation view of mobile pipe formation apparatus 100. FIG. 18 is a detailed elevation view of a part of mobile pipe formation apparatus 100. In some embodiments, mobile pipe formation apparatus 100 further includes a trimmer-finisher 1800 coupled to the frame 102 which in operation trims, as a workpiece, a pipe on the mandrel 104. The trimmer-finisher 1800 includes a saw 142 and a chamferer 144. In some embodiments, mobile pipe formation apparatus 100 includes a plurality of rollers 140 upon which a pipe rests, e.g., pipe 202. In operation, pipe 202 provides a downward force and rests on rollers 140 and, in some configurations, saw 142 or chamferer 144. Rollers 140 provide a stable bed for the operation of trimmer-finisher 1800.

Turning to FIG. 18, which illustrates an elevation view of the mobile pipe formation apparatus 100 and aspects of trimmer-finisher 1800. The trimmer-finisher 1800 includes a saw 142 coupled to frame 102, which in operation, trims, as a workpiece, pipe 202 placed on the mandrel 104. In some embodiments, saw 142 is electrically powered.

In some embodiments, trimmer-finisher 1800 includes a lathe or chamferer 144 coupled to the frame 102 which in operation alters a pipe (e.g., pipe 202), as a workpiece, on the mandrel 104. Altering the pipe includes beveling, chamfering, filleting, or turning down said pipe 202.

In some embodiments, saw 142 and chamferer 144 are both positioned beneath mandrel 104 and firmly coupled to frame 102. In some embodiments, in operation, trimmer-finisher 1800, forms a chamfered edge on pipe 202 at the distal end 122 of pipe 202. In some embodiments, chamferer 144 operates similarly to a lathe, machining the surface of a pipe, e.g., pipe 202. In some embodiments, the saw 142 is positioned after the chamferer 144. The saw 142 operates with two movements perpendicular to the production direction or mandrel 104 and movement in the production direction itself. In some embodiments, a solid spacer is added under the table to accommodate different pipe diameters to adjust the height of one or more of trimmer-finisher 1800, saw 142, or chamferer 144.

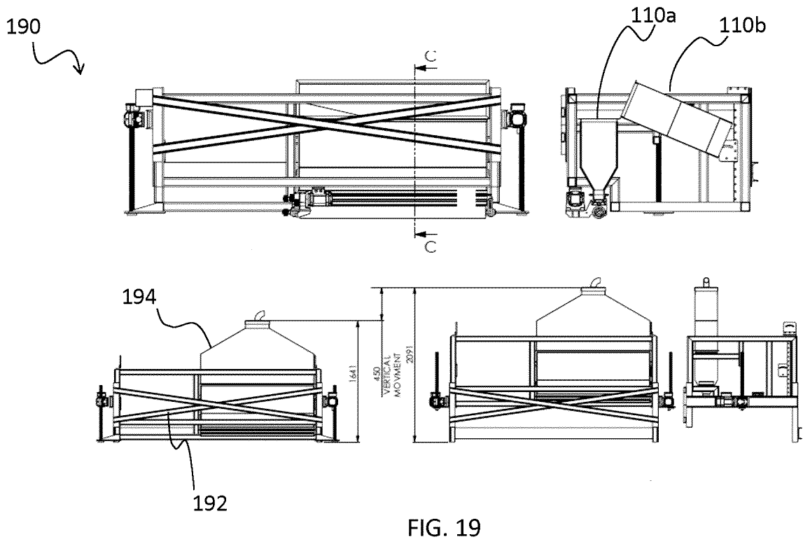

Turning to FIG. 19, which illustrates various views of a feeder system 190 having a fixed structure 192 and a vertically moveable platform 194. The fixed structure 192 is welded to the plurality of mounts 108 of frame 102, while vertically moveable platform 194 is held by the fixed structure 192 and can be vertically moved using a jack screw. The feeder system 190 is positioned low and fitted inside the container during transport and can be adjusted to any elevation based on the pipe diameter in production mode. Also, the sand applicator 110a, 110b are attached to the feeder system 190.

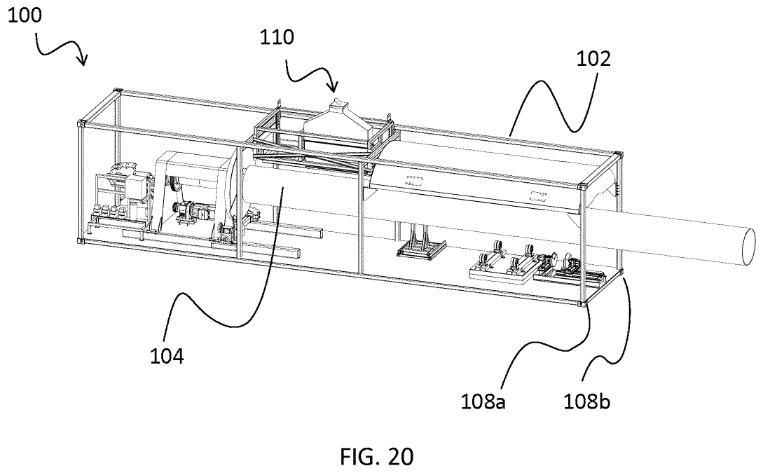

FIG. 20 illustrates a perspective view of the pipe formation apparatus 100 including sand applicator 110 installed in an operational configuration. For example, sand applicator 110 is coupled to frame 102, is unfolded, and above mandrel 104. The sand applicator 110 may be in fluid communication with sand silo 600 (not shown).

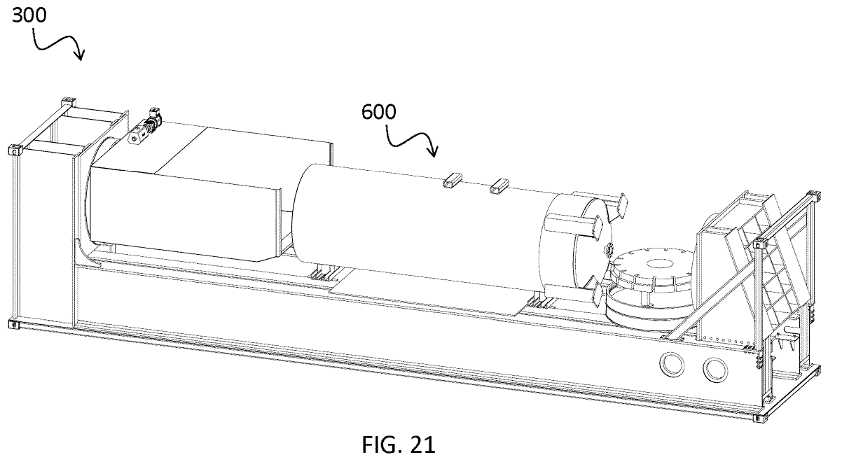

FIG. 21 illustrates a perspective view of hydrostatic pressure test apparatus 300 and sand silo 600 in a transportation configuration. Sand silo 600 is placed on hydrostatic pressure test apparatus 300 to save space.

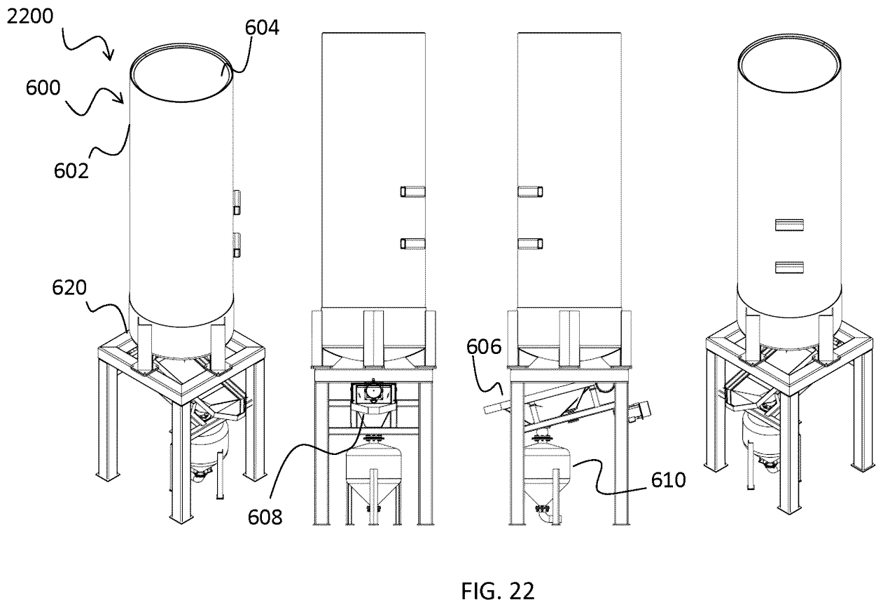

FIG. 22 illustrates multiple views of sand silo system 2200 coupled to sand applicator 110 during a production mode. The sand silo system 2200 includes sand silo 600 overlying a silo stand 620. The silo 600 includes a silo body 602 defining an interior which in operation holds sand, a silo inlet 604 defined in the silo body 602 and an outlet (not shown). The silo 600 further includes a hopper 608 coupling the interior of silo body 602 with the outlet, and coupled to silo stand 620.

In some embodiments, hopper 608 includes sieve 606 to separate large sand particles, promoting the use of appropriately sized particles. Sieve 606 helps maintain consistent sand quality and prevents any potential damage to the pipe after production.

The sand silo system 2200, in some embodiments, includes a sand mover or sand shooter 610 such as a blower, pump, or suction pump. Sand shooter 610 transfers sand from silo 600 to sand applicator 110.

The sand silo system 2200 includes a first configuration and a second configuration such that in the first configuration, at least one of silo body 602 and silo stand 620 are knocked down. While in the second configuration, silo body 602 and silo stand 620 are assembled and silo stand 620 supports silo body 602.

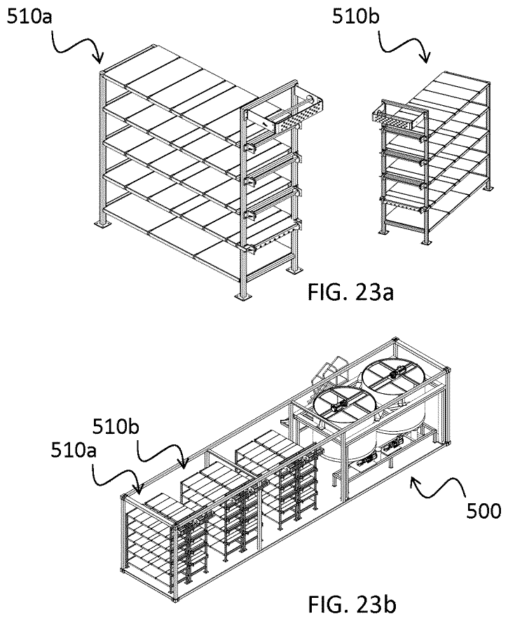

FIG. 23a and FIG. 23b illustrate a plurality of material feeds including a plurality of detachable roving feeds 510a and 510b, and a resin tank 500. In particular, FIG. 23a illustrates the plurality of roving feeds 510a and 510b being detached and outside the resin tank 500, while FIG. 23b illustrates a plurality of roving feeds 510a and 510b attached inside the resin tank 500. In some embodiments, resin tank 500 is attached to the hydrostatic pressure test apparatus 300 for uninterrupted production. In some embodiments, resin tank 500 serves as a primary source of resin. In some embodiments, resin tank 500 allows for continuous workflow by enabling the preparation of fresh resin. Once the first tank is depleted, the prepared resin from the second tank is seamlessly switched online, maintaining efficient production.

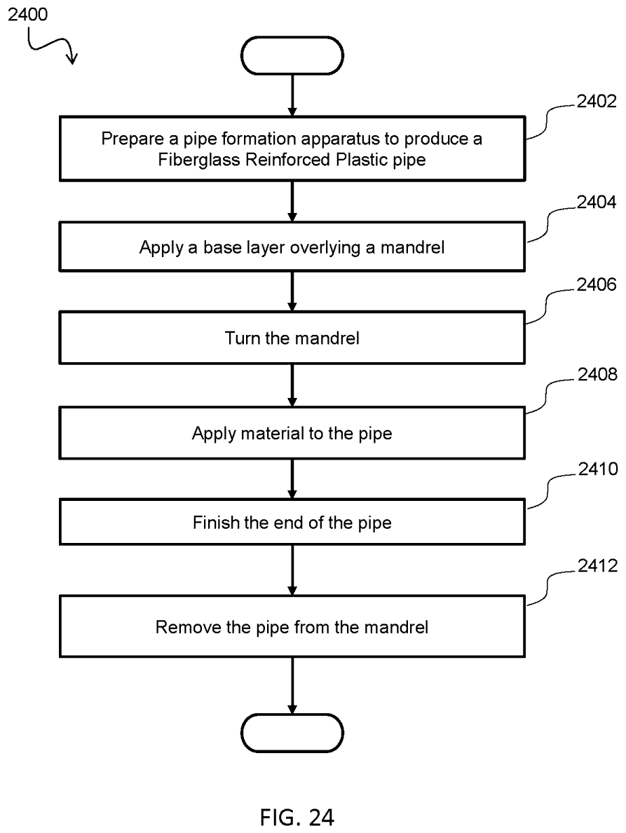

FIG. 24 illustrates a flow diagram of a method of operation of the mobile pipe formation apparatus 100. In particular, FIG. 24 shows method 2400 executable by one or more operators of pipe formation apparatus 100. The pipe formation apparatus 100 may be communicatively coupled, such as by circuitry, to a controller such as at least one hardware processor, for the operation, or improvement in the operation. One or more parts of method 2400 may be performed by the controller. For method 2400 as with other methods disclosed herein, a person skilled in the art will appreciate that other acts may be included, removed, and/or varied or performed in a different order to accommodate alternative implementations.

At 2402, the operators prepare a pipe formation apparatus (e.g. mobile pipe winder, pipe formation apparatus 100) to produce an FRP pipe (e.g., pipe 202, pipe 204, or pipe 206). The pipe formation apparatus includes a mandrel. For example, the operators install plurality of disks 128 on the mandrel, e.g., install plurality of rings 126 to plurality of ferrules 124, and overlying mandrel 104. In some implementations, the operators lower a lift supporting the mandrel 104, e.g., lower lift 114. The operators, in some implementations, may, at 2402, prepare one or more material feeds. Said implementations and setups enable the pipe formation apparatus to efficiently handle or process materials during the pipe winding operation. Some implementations include sliding or clamping plurality of rings 126 onto mandrel 104.

At 2404, the operators apply a base layer overlying the mandrel 104. For example, the operators apply a web to the outer periphery 130 of the plurality of disks 128. Examples of the web include paper. The base layer supports further layers added by the pipe formation apparatus 100. In some implementations, at 2404, the operators turn the mandrel 104 to apply the base layer.

At 2406, the operators turn the mandrel 104. For example, an operator directs a processor to execute processor-executable instructions, and in response, the processor activates a motor coupled to the mandrel 104. The motor drives, e.g., rotates or turns, the mandrel 104—e.g., mandrel 104 turns relative to frame 102.

At 2408, the operators apply materials to the pipe. For example, an operator directs a processor to execute processor-executable instructions, and in response, the processor activates one or more material feeds such as roving feeds 510a and 510b; sand applicator 110, or resin tank 500. In some implementations, plurality of roving feeds 510a and 510b are detached and outside the resin tank 500. The plurality of roving feeds 510a and 510b, in some implementations, are attached inside the resin tank 500. The resin tank 500 serves as a primary source of feeding resin for the current operation. In some implementations, resin tank 500 allows for continuous workflow by enabling the preparation of fresh resin.

At 2410, the operators finish the end of the pipe. In some implementations, the operators direct a processor to execute processor-executable instructions, and in response, the processor activates a trimmer-finisher. In some implementations, the trimmer-finisher (e.g., trimmer-finisher 1800) cuts the pipe and finishes the cut end.

At 2412, the operators remove the pipe from the mandrel 104. In some implementations, the operators direct a processor to execute processor-executable instructions, and in response, the processor activates a puller. In some implementations, the puller urges the pipe off mandrel 104 at the distal end, e.g., distal end 122. The pipe may be used, stored or tested. For examples of testing a pipe, e.g. pipe 206, see the description herein at, at least, FIG. 1-FIG. 11.

Method 2400 ends until invoked again.

For clarity, various embodiments are included in this description. Each is a numbered example.

Example 1: A mobile pipe winder, the winder comprising: a frame including an inferior side and a major axis; a plurality of mounts defined on the inferior side of the frame; a mandrel including a first end coupled to the frame, and a second end projected along the major axis of the frame; a plurality of material feeds which in operation are coupled to the frame; and a lift coupled to the frame and underlying the mandrel.

Example 2: The winder of example 1, wherein the frame has a form factor of a shipping container.

Example 3: The winder of example 1, wherein: the frame includes a minor axis; and the plurality of mounts is spaced apart along the major axis of the frame, spaced apart in the minor axis of the frame, and spaced apart on the inferior side of the frame.

Example 4: The winder of example 1, wherein the mandrel is cantilevered from the first end and rotatably coupled to the frame.

Example 5: The winder of example 1, wherein the lift includes a first configuration and a second configuration such that, in the first configuration the lift is locked off and supports the mandrel by distributing the mass of the mandrel to the frame, and in the second configuration the lift supports a pipe, as a workpiece.

Example 6: The winder of example 1 further comprising a cutter coupled to the frame which in operation trims, as a workpiece, a pipe placed on the mandrel.

Example 7: The winder of example 1, wherein the cutter comprises a chamferer coupled to the frame which in operation alters a pipe, as a workpiece, placed on the mandrel.

Example 8: The winder of example 1 further comprising a plurality of disks coupled to, projecting from, and spaced along the mandrel, wherein:
the plurality of disks includes a plurality of ferrules and a plurality of rings,
the plurality of ferrules is coupled to and distributed along the mandrel, the plurality of rings is detachably coupled to the plurality of ferrules, each ferrule in the plurality of disks has an outer diameter with a partial ordering of diameters such that the largest diameter is proximate to the first end of the mandrel and the smallest diameter is proximate to the second of the mandrel, and a first respective ring in the plurality of disks has an equivalent outer diameter as a second respective ring in the plurality of disks, and an inner diameter corresponding to a respective underlying ferrule coupled to the mandrel.

Example 9: The winder of example 1, wherein the plurality of material feeds, further comprises: a mobile sand silo including a silo body defining an interior which in operation holds sand, a silo inlet defined in the silo body, an outlet, a sand shooter, a hopper coupling the sand shooter and the outlet, and a silo stand coupled to the silo body, wherein: the sand silo includes a first configuration and a second configuration such that in the first configuration, at least one of the silo body and the silo stand are knocked down, and in the second configuration, the silo body and the silo stand are assembled and the silo stand supports the silo body.

Example 10: The winder of example 9, wherein the plurality of material feeds further comprises a foldable sand applicator in fluid communication with the sand shooter

Example 11: The winder of example 1, wherein the plurality of material feeds further comprises a plurality of detachable roving feeds.

Example 12: The device of example 1, wherein the plurality of material feeds further comprises a resin tank.

Each document cited herein was cited to provide clarity to the reader and is incorporated by reference in its entirety. In cases where the present disclosure conflicts with a document incorporated by reference, the present disclosure controls.

To the extent that they are not inconsistent with the specific teachings and definitions herein, all of the U.S. patents, U.S. patent application publications, U.S. patent applications, foreign patents, and foreign patent applications referred to in this specification and/or listed in the Application Data Sheet, including but not limited to any cross-referenced application or priority claim are incorporated herein by reference, in their entirety.

While the disclosure has been described in connection with specific embodiments, it is to be understood that the disclosure is not limited to these embodiments and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

The above description illustrates various embodiments of the present disclosure along with examples of how aspects of particular embodiments may be implemented. The above examples should not be deemed to be the only embodiments or implementations, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

1. A mobile pipe winder, the winder comprising:
a frame including an inferior side and a major axis;
a plurality of mounts defined on the inferior side of the frame;
a mandrel including a first end coupled to the frame, and a second end projected along the major axis of the frame;
a plurality of material feeds which in operation are coupled to the frame; and
a lift coupled to the frame and underlying the mandrel.

2. The winder of claim 1, wherein the frame has a form factor of a shipping container.

3. The winder of claim 1, wherein:
the frame includes a minor axis; and
the plurality of mounts is spaced apart along the major axis of the frame, spaced apart in the minor axis of the frame, and spaced apart on the inferior side of the frame.

4. The winder of claim 1, wherein the mandrel is cantilevered from the first end and rotatably coupled to the frame.

5. The winder of claim 1, wherein the lift includes a first configuration and a second configuration such that, in the first configuration the lift is locked off and supports the mandrel by distributing the mass of the mandrel to the frame, and in the second configuration the lift supports a pipe, as a workpiece.

6. The winder of claim 1 further comprising a cutter coupled to the frame which in operation trims, as a workpiece, a pipe placed on the mandrel.

7. The winder of claim 1, wherein the cutter comprises a chamferer coupled to the frame which in operation alters a pipe, as a workpiece, placed on the mandrel.

8. The winder of claim 1 further comprising a plurality of disks coupled to, projecting from, and spaced along the mandrel, wherein:
the plurality of disks includes a plurality of ferrules and a plurality of rings,
the plurality of ferrules is coupled to and distributed along the mandrel,
the plurality of rings is detachably coupled to the plurality of ferrules,
each ferrule in the plurality of disks has an outer diameter with a partial ordering of diameters such that the largest diameter is proximate to the first end of the mandrel, and the smallest diameter is proximate to the second of the mandrel, and
a first respective ring in the plurality of disks has an equivalent outer diameter as a second respective ring in the plurality of disks, and an inner diameter corresponding to a respective underlying ferrule coupled to the mandrel.

9. The winder of claim 1, wherein the plurality of material feeds, further comprises:
a mobile sand silo including:
a silo body defining an interior which in operation holds sand,
a silo inlet defined in the silo body,
an outlet,
a sand shooter,
a hopper coupling the sand shooter with the outlet, and
a silo stand coupled to the silo body,
wherein:
the sand silo includes a first configuration and a second configuration such that:
in the first configuration, at least one of the silo body and the silo stand are knocked down, and
in the second configuration, the silo body and the silo stand are assembled and the silo stand supports the silo body.

10. The winder of claim 9, wherein the plurality of material feeds further comprises a foldable sand applicator in fluid communication with the sand shooter.

11. The winder of claim 1, wherein the plurality of material feeds further comprises a plurality of detachable roving feeds.

12. The winder of claim 1, wherein the plurality of material feeds further comprises a resin tank.

13. A method of operation in a mobile pipe formation apparatus, pipes made by the mobile pipe formation apparatus are Fiberglass Reinforced Plastic pipes, the method comprising:
preparing mobile pipe formation apparatus wherein the mobile pipe formation apparatus includes a mandrel, and plurality of material feeds;
applying materials from the plurality of material feeds;
turning the mandrel;
trimming a pipe including the materials at a first end; and
after trimming, removing the pipe from the mandrel.

14. The method of claim 13, further comprising chamfering the first end of the pipe.

15. The method of claim 13, further comprising applying a base layer overlying the mandrel wherein the base layer is to underly the materials applied from the plurality of material feeds.
